(19) United States
(12) Patent Application Publication
(10) Pub. No.: US 2012/0312886 A1
(43) Pub. Date: Dec. 13, 2012

(54) DEVICE FOR HEATING A FLUID

(76) Inventor: Johannes Artmayr, St. Lorenz/Mondsee (AT)

(21) Appl. No.: 13/521,256

(22) PCT Filed: Jan. 11, 2011
(86) PCT No.: PCT/AT2011/000008

§ 371 Date: Aug. 17, 2012

(30) Foreign Application Priority Data
Jan. 11, 2010 (AT) A 16/2010

(51) Int. Cl. H05B 3/60; F24D 3/02

(52) U.S. Cl. 237/59; 392/322; 392/323

(57) ABSTRACT

The invention relates to a device (1) for heating a fluid (9), with a housing (2) comprising a housing shell (3), a housing base (4) and a housing cover (5), with at least one inlet opening (11) and at least one outlet opening (13) for the fluid (9), and at least two electrodes are disposed in the housing (2) at a distance (25) apart from one another, which are each electrically conductively connected to a pole of at least one pulse generator (20). At least one other electrode (45 or 46) is provided or at least two other electrodes (45, 46) are provided in the reaction chamber (12), which is/are electrically conductively connected to a power source (47).

The invention relates to a device for heating a fluid, with a housing comprising a housing shell, a housing base and a housing cover, with at least one inlet opening and at least one outlet opening for the fluid, and at least two electrodes are disposed in the housing at a distance apart from one another, in particular at least one anode and at least one cathode, which are each electrically conductively connected to a pole of at least one pulse generator, a heating system comprising at least one device for conveying a first fluid, at least one device for heating a fluid, at least one heat exchanger in which the heat generated by the fluid is transmitted to another fluid, as well as the use of the device for heating a fluid.

Methods of electrical heating are already known from the prior art. They can be sub-divided into resistance heating, arc heating, induction heating systems, dielectric heating systems, electron heating systems, laser heating systems and combination heating system. For example, RU 21 57 861 C discloses a system for recovering thermal energy, hydrogen and oxygen, which operates on a physical-chemical based technology. This device comprises a housing made from a dielectric material, which is provided with an integrally cast, cylindrically conical cam with an end-to-end orifice which, together with the housing, constitutes the anode and cathode chamber. The anode is provided in the form of a flat ring with orifices which sits in the anode chamber and is connected to the positive pole of the power supply source. The rod-shaped cathode is made from heat-resistant material and is inserted in an externally threaded rod, together with which it can be centered in the orifice in the cover by means of a threaded orifice in the housing leading to the interelectrode chamber and is connected to the negative pole of the power supply source. The inlet connectors for initiating operation are disposed in the middle part of the anode chamber.

The disadvantage of the methods and devices known to date as a means of electrically heating solid bodies, liquids and gases resides in the high energy intensity of the heating process. Above all, this results in poor levels of efficiency.

Accordingly, the objective of this invention is to propose an option for heating a fluid which is more economical.

This objective is achieved by the invention, independently in each case, by the device for heating a fluid mentioned above, the heating system and the use of the device proposed by the invention as a means of heating a building, and in the case of the device for heating a fluid, at least one other electrode is provided in the reaction chamber, preferably at least two other electrodes, which is or are electrically conductively connected to a power source, and the heating system comprises at least one device for heating a fluid as proposed by the invention.

Voltage pulses are preferably used in the device proposed by the invention as a means of heating a heat-carrying fluid, in particular water. These voltage pulses are transmitted to the fluid via the at least one anode and the at least one cathode.

The advantage of the device proposed by the invention is that ions are emitted in the fluid by means of this/these additional electrode(s) in the reaction chamber, as a result of which the conductivity of the fluid can be selectively influenced, thereby enabling transmission of the voltage pulses via the cathode and the anode to the fluid in order to heat it can be improved, rather than adding a conductive salt to the fluid, which does enable conductivity to be influenced but depends on the concentration of conductive salt added so that the conductivity assumes a specific value. By contrast with this approach, the conductivity can be controlled or regulated or influenced by means of the other electrode(s). This is of particular advantage if the device proposed by the invention is used in a heating system because the primary circuit of such heating systems in which the device is incorporated usually forms a closed system after initial commissioning except when compensating the pressure or generating overpressure. By influencing conductivity from outside, including during operation, the invention offers the possibility of operating the device with greater efficiency.

At this stage, it should be pointed out that if using only one other electrode, the least one cathode or the at least one anode used for the voltage pulses is the respective opposite electrode for this one other electrode.

The other electrode or the at least two other electrodes are preferably made from a material selected from a group comprising Pd, Pt, Ti, Rh, Au, Ag, Ni, Cu, Ir, Fe, V, Nb, Ta and their alloys, in particular alloys of at least two of these elements in conjunction with one another, and the elements Pd, Pt, Ti, Rh and their alloys are preferred. This results in better stability of the system in the device, especially as regards the service life of the at least one other electrode. Surprisingly, however, an improvement in the degree of efficiency of the device, i.e. the heating power, has also been observed compared with electrodes made from other materials.

The other electrode or at least one of the two other electrodes is preferably disposed in the region of one of the at least two electrodes, in particular the anode or the cathode. As a result of this disposition of the other electrode or at least one of the other electrodes, the fluid in the reaction chamber to which voltage pulses are applied moves into the region of the at least one other electrode shortly after being subjected to the voltage pulses already, so that the molecules of the fluid in this region assume a higher energy state or have a higher energy content due to having been subjected to the voltage pulses so that the ions generated by means of the two other electrodes are improved, in addition to which an effect is produced whereby some of the energy transmitted to the molecules of the fluid is consumed in order to generate the ions and is not available for partially evaporating the fluid, which makes it easier to prevent the formation of larger gas or vapor bubbles on the millimeter scale in the fluid which would impair the degree of efficiency, i.e. the effectiveness of the device.

In practice, it has been found to be of advantage if a distance between the at least two other electrodes is at least 10%, in particular at least 25%, of the length of the reaction chamber, which is defined by the housing. In this respect, the length should be understood as meaning the direction of the longitudinal mid-axis of this reaction chamber and formed by the region in which the at least two electrodes are disposed, in other words specifically the at least one anode and the at least one cathode. This geometric alignment of the two other electrodes enables homogenization of the ions in the fluid emanating from the electrodes to be improved because a sufficiently large mixing run or a sufficiently large volume is available in the housing, i.e. in the reaction chamber, for homogenizing the fluid. Furthermore, it is also possible to apply a relatively low voltage between these two other electrodes so that the process of generating the voltage pulses between the at least two electrodes, in particular the anode and the cathode, is not negatively affected.

It may also be that the other electrode or the at least two other electrodes are bar-shaped with a diameter of at most 30%, in particular at most 20%, of the smallest dimension of at least one of the at least two electrodes, in particular the at least one cathode. On the one hand, this or these other electrode(s) therefore require a relatively small amount of space and on the other hand, the associated small surface of the other electrode(s) is better able to prevent ions being generated in the fluid in too high a concentration so that the device can be more easily controlled because low fluctuations which might occur in the electrical parameters with which the other electrode or the two other electrodes is or operated do not have any significant influence on the fluid.

Based on the preferred embodiment, the power source for the at least two other electrodes is a constant voltage source so as to ensure that the ions are generated continuously in the system.

Based on another embodiment, the other electrode or the at least two other electrodes are activated in an electrolyte bath by means of voltage pulses with an amplitude selected from a range of 5 V to 50 V, in particular 10 V to 20 V, preferably with 15 V, (direct current) and a pulse duration selected from a range of 1 μs to 10 μs, in particular 3 μs to 5 μs, at a current intensity selected from a range with a lower limit of 2000 A, in particular 4000 A, and an upper limit of 8000 A, in particular 6000 A. As a result of this activated surface, it was found that a significant improvement could be obtained in terms of the effectiveness of the two other electrodes and hence an increase in the degree of efficiency of the device.

It is also of advantage if the fluid contained in the reaction chamber, i.e. in the device, is water and an electrolyte is contained in this water so that a certain ability to conduct is already imparted to the fluid, thereby enabling the energy consumption via the two other electrodes to be reduced.

The electrolyte preferably contains water glass (Na₂SiO₃), at least one lye, in particular KOH, distilled or de-ionized water, and optionally Na₂SO₃ and/or K₂SO₄, which offers advantages in terms of generating ions via the two other electrodes on the one hand whilst ensuring that electrolyte contained in the device will not cause environmental problems on the other hand.

The at least two other electrodes may be disposed in the direction of a longitudinal extension of the housing and coaxially with one another in the housing, thereby offering advantages in terms of smoothing the fluid after applying the voltage pulses due to the small active surface between the two other electrodes, which is essentially limited to the mutually opposite end regions of the other electrodes.

Another option is to provide a smoothing section for the fluid in the flow direction of the fluid following the at least two electrodes, in particular the at least one cathode or the at least one anode. The advantage of this is that it at least partially prevents larger bubbles from forming in the fluid across the smoothing section. This means that energy introduced into the system is not used for partially damping the fluid. Furthermore, this also makes for a more uniform distribution of the heat transmitted to the fluid. It is a known fact that bubbles have a certain heat-insulating effect. Preventing bubbles results in a more homogenous temperature range within the fluid. Moreover, it also means that because a more homogenous temperature distribution can be obtained in the fluid, thereby enabling “hotspots” to be avoided, the device can be operated with a lower energy input via the electrodes, which in turn enables the degree of efficiency to be improved and results in more economic operation of the device.

The smoothing section is preferably disposed in the housing. On the one hand, this makes for a more compact construction of the device and, on the other hand, additional eddying cannot occur in the region of flow connections between the housing in which the electrodes are disposed and the smoothing section.

The smoothing section preferably has a length which is 100%, in particular 150%, to 500%, in particular 350%, longer than a longitudinal extension of at least one of the at least two electrodes, in particular the anode or the cathode, in the flow direction of the fluid. During testing of the device, it has been specifically established that smoothing sections which are too short do not produce the desired effect overall in terms of maintenance. Surprisingly, however, it was found that smoothing sections which are too long go hand in hand with a reduction in economic operation, even though they should actually improve the effects outlined above. The reason for this has not been established as yet.

In the region of the smoothing section, the housing may have an at least partially bigger clearance width than the region of the housing in which the at least two electrodes are disposed, in particular the cathode and the anode. Due to this cross-sectional widening, the flow speed of the fluid in the region of the smoothing section is lower than in the region of the housing in which the electrodes are disposed, which means that the smoothing section as a whole can be made shorter because the fluid “dwells” for a longer time in the smoothing section which means that a longer time is available to impart smoothness to the fluid. At the same time, a higher pressure acts on any vapor or gas bubbles in the smoothing section, so that the latter are more effectively reduced in size or at least partially destroyed in this cross-sectional widening.

Another option is to dispose at least one deflector plate in the smoothing zone in order to impart a pre-definable flow to the fluid which is conducive to smoothing the fluid.

Another possibility is to provide at least one light-emitting diode in or alongside the smoothing section, in particular a high-power light-emitting diode. It was observed that radiating light in at a specific frequency or in a specific frequency range resulted in a significant reduction of large bubbles in the fluid by generating bubbles of micro-dimensions. It is assumed that radiating into the fluid at specific frequencies causes interactions to occur with the molecules of the fluid, thereby at least partially inducing natural vibrations in the molecule, and this vibrating behavior in the molecules of the fluid at least largely prevents or avoids the formation of large bubbles in the same way as the formation of large gas bubbles in a fluid is prevented using mechanical devices, such as agitators for example, or boiling chips such as used in chemistry to prevent boiling delays.

If using water as the heat-carrying medium, it has been found to be of advantage if the at least one light-emitting diode emits white light.

However, it is also possible to dispose several light-emitting diodes in or along the smoothing section, which emit light in a different wavelength spectrum. On the one hand, this enables the frequency to be adapted to the heat-carrying medium, i.e. its molecules or molecule structures, more easily because it is known that molecular vibrations or the excitation of rotational states in the molecule requires specific wavelengths. By providing a wavelength spectrum which is broader, reliability is improved in terms of achieving the effect. On the other hand, this makes it possible, in particular if an electrolyte is added to the heat-carrying medium, i.e. water for example, to provide heat in the region of the electrodes, for these electrolyte ions present in the heat-carrying medium to contribute to preventing the formation of bubbles.

The light-emitting diodes or the light-emitting diode are/is preferably disposed in a peripheral region of the housing shell, so that a better distribution of the amount of light radiated into the fluid is achieved due to corresponding refractory effects or diffraction effects.

Based on another embodiment, the light-emitting diodes are electrically conductively connected to a device for generating intermittently occurring light. Similarly to a stroboscope, therefore, light pulses are introduced into the fluid. During the pulse pauses, the excited fluid particles are able to revert to the original state, thereby enabling the effectiveness of the process of destroying the large gas bubbles to be improved.

In order to improve the effectiveness of the process of applying voltage pulses to the fluid in the region of the housing in which the electrodes are disposed, at least one of the at least two electrodes, in particular the anode, is based on a basket-shaped design, and in another embodiment, it is preferable if at least one of the least two electrodes is disposed at least partially inside the basket-shaped electrode, in particular the cathode is disposed at least partially inside this basket-shaped anode. This enables a more homogeneous distribution of the charge carriers introduced into the fluid to be improved.

It was also observed that the effectiveness of the device and as a consequence the heating system can be improved if the distance between the at least two electrodes, in particular between the cathode and the anode, is at least 5 mm, in particular at least 7 mm. This is also of particular importance with respect to the formation of bubbles so that the selected distance has a supporting effect on the smoothing section.

Based on the preferred embodiment of the device proposed by the invention, the housing shell is of a cylindrical design, leading to a positive flow behavior of the fluid by avoiding edges, etc., thereby avoiding eddying in the fluid.

Another approach is to dispose at least one of the least two electrodes in the housing so that it can be moved in a relative displacement towards the other electrode, in particular the anode is moved relative to the cathode and/or the cathode relative to the anode. This enables the distance between the at least two electrodes to be readjusted, even during operation of the device, in order to improve the effectiveness of the device proposed by the invention.

Based on another option, at least one laser may be disposed in the smoothing section. The ions originating from the two other electrodes or from the added electrolyte can be activated by the laser, thereby enabling the conductivity of the fluid and hence the effectiveness of the process of introducing voltage pulses into the fluid to be improved.

The laser preferably emits light at a frequency selected from a range with a lower limit of 300 THz, in particular 410 THz, and an upper limit of 550 THz, in particular 490 THz.

Another option in this respect is for the laser to be connected to a device for generating intermittently occurring light, and in the case of one embodiment the laser emits light pulses with a pulse duration selected from a range with a lower limit of 20 μs, in particular 33 μs, and an upper limit of 100 μs, in particular 50 μs. Similarly to the embodiment of the invention using intermittently occurring light from the light-emitting diode(s), it was found that in practice, intermittently occurring laser light improves the heating performance of the device and the heating system, in particular at a frequency within the specified range.

Based on a preferred embodiment of the heating system, the heat exchanger is provided in the form of a radiator, in which case this heating system is designed in particular for heating the ambient air of a building.

To provide a clearer understanding, the invention will be described in more detail with reference to the appended drawings.

These are schematically simplified diagrams illustrating the following:

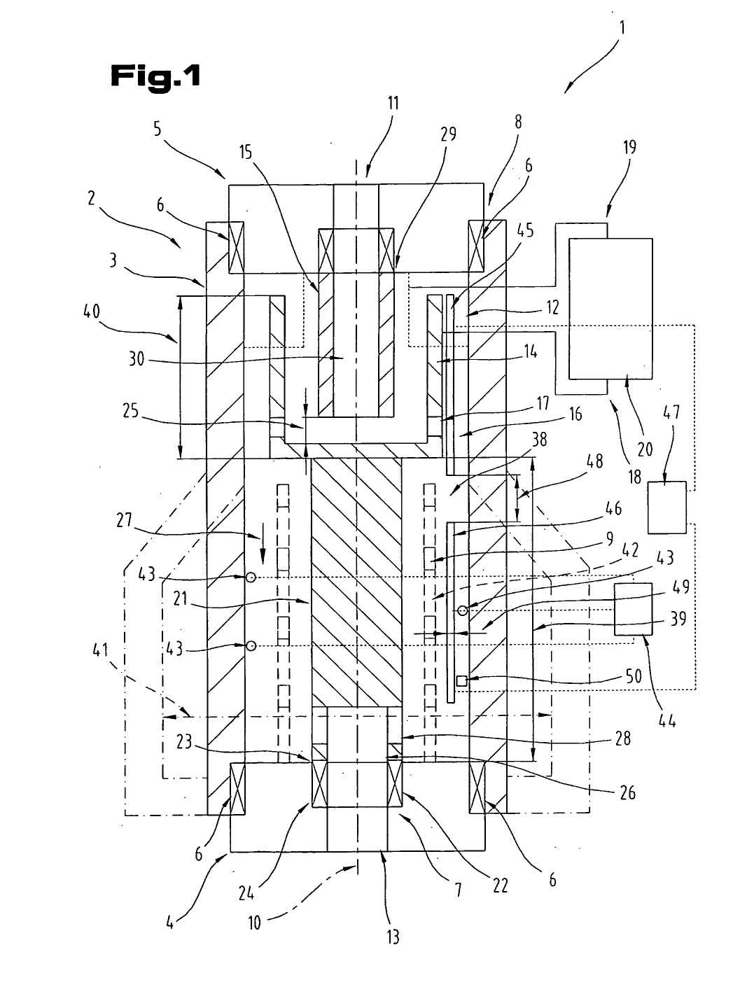

FIG. 1 illustrates an embodiment of a device for heating a fluid;

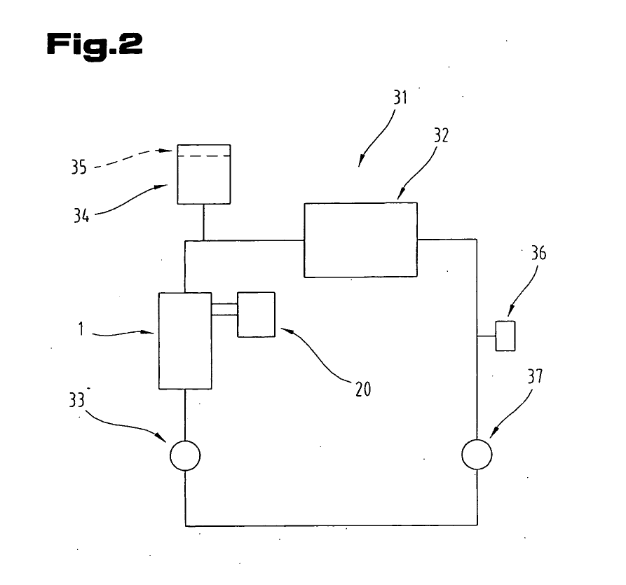

FIG. 2 shows a heating system;

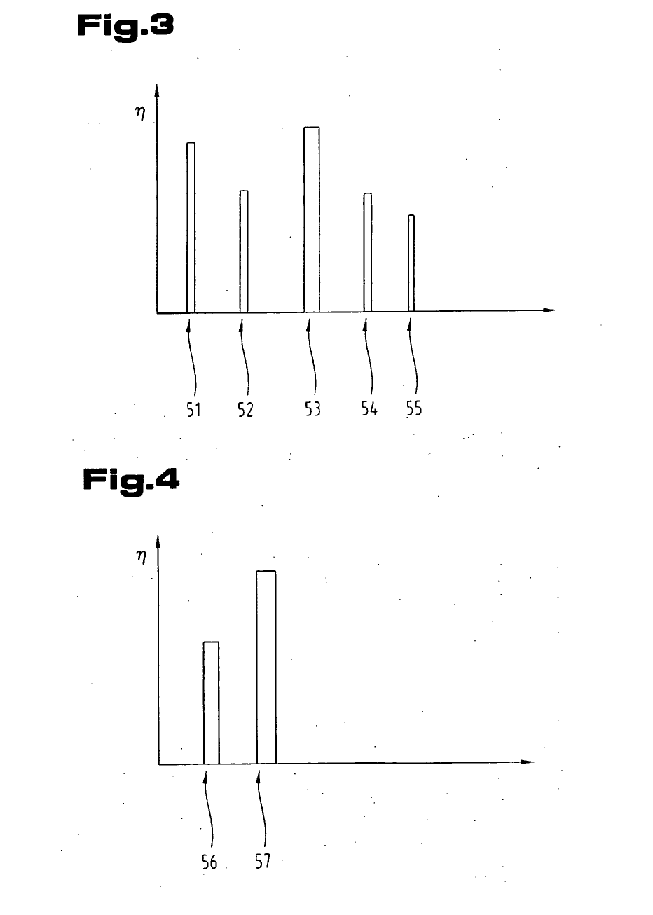

FIG. 3 illustrates how the choice of material for the two other electrodes influences the degree of efficiency of the device;

FIG. 4 illustrates how activating the two other electrodes influences the degree of efficiency of the device.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 illustrates a device 1 as proposed by the invention for heating a fluid, preferably water. It comprises a housing 2, comprising a housing shell 3, as well as a housing base 4 and a housing cover 5. The housing 2, i.e. the housing shell 3 and/or the housing base 4 and/or the housing cover 5, are preferably made from a dielectric material, for example a plastic, e.g. PE, PP, PVC, PS, Plexiglas etc.

As may be seen from FIG. 1, both the housing base 4 and the housing cover 5 are each screwed by means of an internal thread in the housing shell 3—a thread 6 is provided in each case at each of the two end regions 7, 8 of the housing shell 3—and a co-operating external thread on the housing base 4 and on the housing cover 5 to the housing shell 3 so that the housing base 4 and the housing cover 5 can be removed from the housing shell 3. Instead of the screw connections, it would naturally also be possible to enable this removal by simply sliding the housing base 4 or housing cover 5 into the housing shell 3, in which case care must be taken with this embodiment to ensure that the requisite tight seal is obtained, e.g. by providing sealing rings or similar, such as O-rings. In addition, however, it is also possible for the housing base 4 and/or the housing cover 5 to be disposed in the housing shell 3 by means of a press-fit connection or to be connected to it by some other means, e.g. welding, etc. Another option is one where only the housing base 4 or only the housing cover 5 can be removed from the housing shell 3. Yet another option is for the housing 2 to be designed as an integral part with the housing base 4 and/or housing cover 5.

Based on the embodiment of the device 1 illustrated in FIG. 1, the housing 2 is cylindrical in shape. Naturally, however, it would also be possible for the housing 2 to be of a different three-dimensional shape, e.g. cubic, etc. The cylindrical design enables the flow resistance opposing a fluid 9 conveyed through the device 1, in particular water, to be reduced.

The housing cover 5 has a recess along a longitudinal mid-axis 10. e.g. in the form of a bore, serving as an inlet opening 11 for the fluid 9 into the device 1, i.e. into a reaction chamber 12 of the device 1.

An outlet opening 13 in the form of an axial bore is provided in the housing base 4, ensuring that the fluid 9 is able to drain out of the reaction chamber 12.

However, both the inlet opening 11 and the outlet opening 13 may be disposed at a different point in the housing 2 of the device 1, for example in the housing shell 3, or radially in the housing base 4 or housing cover 5, in order to impart a tangential flow to the incoming fluid 9.

Alternatively, more than one inlet opening 11 and/or more than one outlet opening 13 could also be provided, in which case an opening in both the axial and/or radial direction would be possible, for example one or more inlet openings 11 in the axial direction and one or more inlet openings 11 in the radial direction and/or one or more outlet openings 13 in the axial direction and one or more outlet openings 13 in the radial direction.

At least one anode 14 and at least one cathode 15 are disposed in the reaction chamber 12. The anode 14 is preferably of a basket-shaped design and the at least one cathode 15 is disposed at least partially inside the space defined by the anode 14, as illustrated in FIG. 1. To facilitate through-flow of the fluid 9, the anode 14 may be provided with one or more orifices 17 in an end region 16 facing the housing base 4, preferably oriented in the radial direction so that the fluid 9 leaves the region inside the reaction chamber 12 defined by the anode 14 deflected in the direction perpendicular to the longitudinal mid-axis 10. However, another option is for the anode 14 to be based on a lattice-type design or, alternatively or in addition to the orifice 17 or orifices 17, such orifices could also be provided in the part of the anode 14 facing the container base 4, in other words the “base” of the basket-shaped anode 14. In this connection, it is possible for the anode 14 as well as the cathode 15 to be of a bar-shaped design in one embodiment. Also, several anodes 14 and cathodes 15 may be provided, in which case it is preferable to opt for an alternating arrangement of the anodes 14 and cathodes 15, thereby forming pairs comprising an anode 14 and a cathode 15.

The at least one anode 14 is electrically conductively connected to a positive pole 18 and the at least one cathode 16 to a negative pole 19 of a pulse generator 20.

The distance 25 between the cathode 15 and the anode 14 is at least 5 mm, in particular at least 7 mm.

As illustrated in FIG. 1, the anode 14 in this embodiment is disposed in the reaction chamber 12 at a distance apart from the housing base 4. To obtain this spacing, a dome-shaped shoulder 21 is provided in the housing base 4 in the region of the outlet opening 13 for the fluid 9 from the reaction chamber 12, which can be used to adjust the height of the at least one anode 14. In particular, this shoulder 21 is in turn of a rotationally symmetrical, bolt-shaped design and is retained in a central bore 22 in the housing base 4.

However, this shoulder 21 may also be based on any other geometric shape, for example a prism, in which case this bore 22 will be of a shape matching the external circumference of the shoulder 21.

It is also possible that this shoulder 21 does not extend through the housing base 4 and instead is placed on it, e.g. is glued to it or connected to the housing base 4 by some other joining technique, such as welding for example. In this example of an embodiment, this shoulder 21 is provided with an external thread 23, which locates in an internal thread 24 of the bore 22. This enables the height of this shoulder 21 to be adjusted to a certain degree so that a distance 25 between the anode 14 and cathode 15 can be adjusted, in other words the depth by which the cathode 14 extends into the basket-shaped anode 14 in this embodiment.

In addition to screwing the shoulder 21 in and out, another option is to design it so that it slides into the bore 22, thereby offering another way of adjusting this distance 25.

Along the course of the longitudinal mid-axis 10, this shoulder 21, which is preferably also made from a dielectric material, has an opening 26 which does not extend in the direction of the longitudinal axis 10 and which is disposed in the flow direction of the fluid 9 (arrow 27) behind the opening 10 in the housing base 4.

At least one radial bore 28 is provided in the shoulder 21 in the region of the housing base 4, through which the fluid 9 is able to flow out of the reaction chamber 12. However, it would also be possible for the outlet opening 13 to be disposed not centrally in the housing base but off-center and adjacent to the mount for the shoulder 21 in the housing base, in which case this/these radial bore(s) 28 can be dispensed with. However, the advantage of the first of the above-mentioned variants is that the dwell time of the fluid 9 in the reaction chamber 12 can be lengthened, which is of advantage in terms of smoothing the fluid 9 in the context of the invention. Another option is to provide several radial bores 28 at different heights in the shoulder 21.

In this respect, it is possible for the housing base 4 and the shoulder 21 to be of an integral design in one embodiment, in which case, the height adjustment and hence the adjustment of the distance 25 can be obtained by screwing the housing base 4 into the housing shell 3.

The anode 14 may also be designed so that it at least partially surrounds the shoulder 21. Towards the bottom, i.e. in the direction towards the housing base 4, the anode 14 in this variant may be fixed in its vertical position by an appropriate fixing means, e.g. a nut or a circumferentially extending web or such like. In the simplest case, the anode 14 may sit on this fixing means so that it can be removed. However, it may naturally also be connected to this fixing means.

Another option is one where the anode 14, although based on a basket-shaped design, extends only in the direction towards the housing base 4. In this case, the cathode 15 has a surface extension extending parallel with the base of the anode 14, although it could also be fitted with its active surface extending horizontally only as opposed to the vertical orientation of this surface illustrated in FIG. 1.

The cathode 15 in this embodiment is likewise cylindrical. The cathode 15 is also retained in an axial bore 29 of the housing cover 5, and this axial bore 29 may naturally have a bigger diameter than the inlet opening 11 for the fluid 9.

This cathode 15 is preferably designed so that it can be screwed into or inserted in the axial bore 29. Alternatively, it would naturally also be possible for the cathode 15 to be connected to the housing cover 5 so that it cannot be moved.

To enable the fluid 9 to enter the reaction chamber 12, this cathode 15 may have a centrally disposed, continuous bore 30 in the flow direction of the fluid 9 (arrow 26) adjoining the inlet opening 11.

At this stage, it should be pointed out that the term bore is used in these descriptions of the subject matter but it would naturally be possible to choose different geometries for the object inserted in it and these bores may therefore generally be termed recesses with cross-sections adapted accordingly.

The cathode 15 may be entirely or partially covered by the housing cover 5 in the radial direction, in which case it is of advantage to provide a co-operating bore ore recess in the housing cover 5 with a bigger diameter than the axial bore 29, to enable a cathode chamber to be provided in the region of the cathode 15, as indicated by broken lines in FIG. 1. The housing cover 5 may also cover the cathode 15 in the direction towards the reaction chamber 12.

It would also be possible to provide at least one inlet opening 11 in an off-center disposition in the housing cover 5 so that the fluid does not have to flow through the cathode 15 and hence the axial bore 29.

Another option is for the cathode 15 to be closed in the bottom end region pointing in the direction towards the container base 4, in which case at least one radial bore is provided in the cathode 15 to allow the fluid 9 to pass into the reaction chamber 12.

As already mentioned, it is possible to provide several individual anodes 14 and several individual cathodes 15 in the reaction chamber 12, for example in the form of electrode plates or lattice-type electrodes, in which case these may optionally form packets.

Generally speaking, the anode 14 and the cathode 15 may be disposed one after the other in the flow direction of the fluid 9 or adjacent to one another.

Another option is not to dispose the housing base 4 and/or housing cover 5 in an inner bore of the housing shell 3 but conversely, to dispose them extending externally on the housing shell 3 in the manner of a push-on or screw-on cover 5.

The size of the reaction chamber 12 is variable, especially as regards the desired heating power of the device 1, which may be 5 kW to 40 kW, for example.

This also enables the actual flow speed of the fluid 9 in the reaction chamber 12 to be influenced.

The housing base 4 and/or the housing cover 5 may have stud-type projections at its outer ends, for example to facilitate connection of the heat generator 1 to a heating circuit or similar. To this end, these stud-type projections of the housing base 4 and housing cover 5 may be provided with appropriate threads. Naturally, it would also be possible to use a standard screw connection with clamping nuts or similar, e.g. a conical face pipe union of the type known in the heating industry.

Based on one embodiment, it is possible for the shoulder 21 to extend through the housing base 4 so that it can be operated from outside, i.e. outside of the reaction chamber 12, for example in order to correct the set distance 25 between the anode 14 and cathode 15 subsequently or to set it from outside.

Yet another option is to enable the height of the cathode 15 to be adjusted as well as that of the anode 14 or to use a design in which only cathode 15 can be displaced in terms of its position relative to the anode 14.

In this respect, it should be pointed out that the displacement could naturally be motor-driven or may be done manually only, for which purpose the shoulder 21 may be provided with an appropriate drive, for example. This drive may be based on a micro-electronic design, given that the absolute distances of the displacement during operation of the device 1 are not that great but should be understood as being nothing more than fine adjustments provided the correct distance 25 between the anode 14 and cathode 15 was set during initial operation. It is merely a question of compensating for any heat expansion which might have occurred with a view to further improving or optimizing the efficiency of the device 1.

Depending on the desired power rating of the device 1, the distance 25 between the at least one anode 14 and the at least one cathode 15 may be selected from a range with a lower limit of 7 mm and an upper limit of 10 cm or with a lower limit of 10 mm and an upper limit of 5 cm, the energy yield within this range being surprisingly high.

Both the anode 14 and the cathode 16 are usually made from a metal material.

The anode 14 may also be mounted in the housing in a different manner, for example likewise by means of the container cover 5, in which case the shoulder 21 can be dispensed with so that the region of the reaction chamber 12 after the electrodes can be made bigger or the housing made to a more compact design. Another option is for the anode 14 to be supported on a projection of the housing shell 3 pointing in the direction towards the longitudinal mid-axis 10.

The flow direction of the fluid 9 in terms of the intake may also be reversed, in which case this fluid 9 is fed in through the shoulder 21. To this end, an outlet opening may be provided in the anode 14 in the region where it adjoins the shoulder 21, via which the fluid 9 is fed into the region between the anode 14 and cathode 15. After flowing through this region, the fluid 9 is deflected in the region of the container cover 5 and fed back out of the reaction chamber 12 via at least one of the off-center outlet openings in the container base.

FIG. 2 illustrates the preferred possible application of the device 1 proposed by the invention. It is disposed in the circulation circuit of a heating system 31, e.g. a central heating system or a radiator 32. The radiator 32 may be made from any material, in particular stainless steel, copper or similar.

The device 1 further comprises the pulse generator 20. Naturally, other devices may be provided as necessary, such as at least one pump 33, at least one expansion tank 34, optionally a gas absorber 35, over-pressure safety features, control and measuring devices, etc., of the type known from heat engineering in the central heating sector. It would naturally also be possible to incorporate other control units 37.

The pulse generator 20 may be based on an electro-mechanical or electronic design. In the case of an electro-mechanical design, the pulse generator comprises an electric motor, a voltage pulse generator and a pump, in particular a hydraulic pump, these elements of the pulse generator 20 being disposed in the specified order on a common shaft. By contrast with the electro-mechanical pulse generator 20, the electronic pulse generator 20 is preferably of a modular design, and in a first power-feed module, e.g. a transformer, the electrical energy fed in from the grid or other power sources, e.g. accumulator, etc., is galvanically separated from the earthed power system. In the situation where alternating current is fed in, the supplied energy is optionally rectified in a rectifier module, e.g. with conventional rectifier elements known from the prior art. A supply module is conductively connected to the power-feed module or rectifier module, by means of which the continuous direct voltage is transformed into a pulsing direct voltage. This pulsing direct voltage is then applied via the anode 14 and cathode 15 to the fluid 9 in the gap between the electrodes. For regulating and/or control purposes, it is preferable to provide a regulating and/or control module comprising individual capacitors, transistors, at least one IGBT, which in the case of one embodiment may be provided in the form of a circuit board, for example. This regulating and/or control module regulates and/or controls pulse widths, pulse durations as well as the repeat frequency of the voltage pulses, for example. To this end, a temperature taken from a temperature regulating circuit may be applied as the regulating criterion, and this temperature regulating circuit receives data based on the temperature of the fluid 9, in particular the desired temperature of the fluid 9 in the heating system 31. In this heating system 31, it is possible to provide thermostats as temperature sensors of a type known per se.

Other input variables used for regulating purposes might include chemical and physical parameters, for example the pH value of the fluid 9 or a pressure or a concentration of a chemical additive for the fluid 9, for example a lye, or the electrical conductivity of the fluid 9.

The voltage pulses can therefore be adjusted in terms of both pulse shape and amplitude, and in particular the steepness of the flanks (dU/dt) of the voltage pulses can be adjusted and regulated from the pulse generator 20, in particular the rising flank and/or the trailing flank. It is therefore possible to set up voltage pulses with a steeply rising and flat or gently trailing flank, in particular rectangular pulses.

As already mentioned, this electronic pulse generator 20 may be supplied with primary energy, i.e. electric current, directly from the supply network of the power supplier. It would also be possible to feed in different signal shapes with different frequencies via an intermediate circuit from any power source, for which purpose transistors etc., known from the prior art are used in the electronic pulse generator 20 in order to obtain the ultimately desired pulse shape.

In order to prevent overheating of the pulse generator 20, it may be provided with an appropriate cooling module, for example in the form of cooling ribs, e.g. made from aluminum sections.

The operating mode of the device 1 can be summarized as follows. The pulse generator 20 is switched to the supply network, i.e. the power network. The voltage pulses generated by the latter are transmitted via the anode 14 and cathode 15 to the fluid 9 in the flow circuit of the heating system 31, where they generate the desired heat in the fluid 9. As this takes place, the fluid 9 is kept in circulation by the pump 35, which may be provided as a component of the electro-mechanical pulse generator 20 on the one hand or, if using an electronic pulse generator, as a separate component of the heating system 31. The fluid 9 is preferably circulated in a closed circuit through the circulation units of the heating system 31 and hence also through the device 1, in particular its reaction chamber 12.

At this stage, it should be pointed out that instead of a radiator 32, it would also be possible to use other types of heat exchanger, for example plate heat exchangers with a large surface area, tube heat exchangers, etc., where the heat from the fluid primarily heated by the device 1 is transmitted to a secondary fluid in a known manner, in order to heat houses, industrial installations or similar, for example.

It has proved to be of advantage if the fluid 9 has a basic medium added to it so that it has a basic pH value. In this respect, the pH value may be selected from a range with a lower limit of 7.1 and an upper limit of 12 or more especially preferably with a lower limit of 9 and an upper limit of 11. In order to create the basic pH values, any basic medium may be used in principle, but particularly preferred are caustic soda, potash, calcium hydroxide or calcium carbonate.

As illustrated in FIG. 1, the device is disposed after the at least one anode 14 in the flow direction of the fluid 9 (arrow 27) or, if the anode 14 and cathode 15 are disposed in the reverse arrangement so that the cathode 15 is disposed after the anode 14 in the flow direction of the fluid 9 in the reaction chamber 12, the smoothing section 38 for the fluid 9 is provided after the cathode 15.

The term “smoothing” within the context of the invention is intended to mean that any larger gas or vapor bubbles which might have been generated due to partial evaporation of the fluid 9 when voltage pulses were applied to the fluid 9 between the anode 14 and cathode 15 are reduced or made smaller in the fluid 9 to micro-dimensions during the course of the smoothing section 38.

The expression “smoothing section” should be construed as meaning a volume in which the fluid 9 is disposed for smoothing purposes, and which is preferably disposed immediately adjoining the region of the housing 2 in which the electrodes are disposed in the flow direction of the fluid 9.

In the case of the embodiment illustrated in FIG. 1, the smoothing section 38 is disposed in the housing 2 itself. Another option would be to provide this smoothing section 38 as a separate component adjoining the housing 2. In this case, given the cylindrical shape of the device 1 illustrated in FIG. 1, another housing shell is connected to the housing 3, for example screwed to it, and the screw fitting may optionally be provided by means of an appropriate thread on the housing base 4 of the device 1.

This smoothing section 38 preferably has a length 39 which, in the case of the embodiment illustrated, extends from the bottom face of the anode 14 pointing towards the housing base 4 to the surface of the container base 4 pointing in the direction towards the anode 14, as illustrated in FIG. 1. In general terms, the smoothing section 38 in this embodiment is disposed between the electrodes, i.e. the lowermost electrode in the direction towards the housing base, and the housing base 4.

The length 39 is 100% to 500% longer than a longitudinal extension 40 of the anode 14 or corresponding electrode. In particular, this smoothing section 38 has a length 39 which is 150% to 350% longer than the longitudinal extension 40 of the anode 14 in order to improve the degree of efficiency of the device 1.

Based on another embodiment of the invention indicated by broken lines in FIG. 1, the smoothing section 38 has an at least partially bigger clearance width 41 than the region of the housing 2, i.e. reaction chamber 12, in which the electrodes are disposed, i.e. the cathode 15 and the anode 14. Accordingly, it is possible for the housing base 4 to be selected so that it is also bigger in terms of its diameter or, as indicated by broken lines in FIG. 1, this clearance width 41 can be reduced in the region of the housing base 4 to the value corresponding to the clearance width in the region of the electrodes.

The widening of the cross-section, i.e. the widening of the clearance width 41, preferably extends unchanged following a transition region into the region of the housing base 4, with a view to avoiding additional eddies in the smoothing section 38.

To improve the effect still further, i.e. impart further smoothness to the fluid 9, at least one deflector plate 42 may be disposed in this smoothing section 38 or smoothing zone of the housing 2. This deflector plate 42 may be connected to the housing shell 3 and/or, as indicated by broken lines in FIG. 1, to the housing base 4, and radial bores may be provided in the deflector plate 42 across the length of the deflector plate 42 in the direction of the length 39 of the smoothing section 38 in order to permit a flow connection between the individual regions of the smoothing section 38 that are separated from one another. Alternatively, however, a separate outlet opening 13 may be provided in the housing base 4 for the individual separated regions of the smoothing section 38.

In the embodiment of the invention illustrated in FIG. 1, the deflector plate 42 is cylindrical in shape. However, it would also be possible to provide individual, mutually separate deflector plates 42 in the smoothing section 38. The expression “deflector plate” as used within the meaning of the invention should also be construed as including other types of flow deflector elements, for example of the lattice, knitted or net type.

Based on another embodiment of the invention, at least one light-emitting diode 43 is provided in the smoothing section 38, and in the case of the embodiment illustrated in FIG. 1, three light-emitting diodes 43 are provided. These light-emitting diodes 43 preferably emit white light. In the layout of light-emitting diodes 43 illustrated in FIG. 1, the latter are distributed along the length 39 of the smoothing section 38, i.e. they are disposed at different heights in the reaction chamber 12. However, another possibility would be to dispose these light-emitting diodes 43 at the same height, although the former embodiment of the invention is preferred.

The light-emitting diodes 43 may emit light in the same wavelength range. Alternatively, for the reasons outlined above, one option is to use light-emitting diodes 43 which emit light in different wavelength ranges and in this embodiment, the light-emitting diodes 43 emit a light other than white, for example at least one light-emitting diode 43 may emit blue light and at least one other light-emitting diode 43 emits red light.

In the variant illustrated in FIG. 1, the light-emitting diodes 43 are disposed in the peripheral region of the housing shell 3. In principle, however, these light-emitting diodes 43 could also be disposed in the housing shell 3 or offset farther in the direction towards longitudinal mid-axis 10, and yet another option is for these light-emitting diodes 43 to be disposed at different distances from the housing shell 3 in the reaction chamber 12, i.e. the smoothing section 38.

Based on one particular embodiment of the invention, at least one of the light-emitting diodes 43, preferably all of them, is electrically conductively connected to a device 44 configured to emit an intermittent light. A pulse pause of the light pulses may be selected from a range with a lower limit of 1 μs and an upper limit of 50 μs. A pulse duration of the light pulses may be selected from a range with a lower limit of 20 ns and an upper limit of 20 μs.

The pulse frequency as well as the pulse duration and the pulse pauses of the light pulses emitted by the light-emitting diodes 43 may be selected so as to remain constant but these light pulses are preferably emitted with at least one variable value, i.e. the pulse duration and/or the pulse pauses changes when the light pulses are being applied to the fluid 9. This change may be regular or totally random.

In order to achieve this, an appropriate random number generator may be provided in the device 44, or this could also be achieved on the basis of software using appropriate EDP programs.

In terms of pulse frequencies for the voltage pulses, it has proved to be of particular advantage to opt for frequencies selected from a range of with an upper limit of 500 Hz and a lower limit of 100 Hz, in particular with an upper limit of 300 Hz and a lower limit of 150 Hz. However, the pulse frequency of the voltage pulses may also be selected from a range with a lower limit of 20 Hz, in particular 800 Hz, preferably 2530 Hz, and an upper limit of 20 kHz, in particular 11 kHz.

The pulse duration of the voltage pulses may be selected from a range with a lower limit of 10 μs and an upper limit of 250 μs, in particular from a range with a lower limit of 40 μs and an upper limit of 200 μs.

The pulse amplitude of the voltage pulses may be selected from a range with a lower limit of 330 V and an upper limit of 1500 V, in particular from a range with a lower limit of 500 V and an upper limit of 1200 V.

The pulse pauses between the voltage pulses may be selected from a range with a lower limit of 2 μs and an upper limit of 20 μs, in particular from a range with a lower limit of 5 μs and an upper limit of 8 μs.

As proposed by the invention, at least two other electrodes 45, 46 are disposed in the reaction chamber 12, which are electrically conductively connected to a power source 47. Based on an appropriate design, the power source 47 may also be disposed in the pulse generator 20 and in the case of this embodiment, care must be taken to ensure that power is supplied to the two other electrodes 45, 46 without any mutual influence on the power supply of the electrodes used to generate the voltage pulses between the anode 14 and the cathode 15.

Naturally, it would also be possible within the scope of the invention to provide more than two other electrodes 45, 46 in the reaction chamber 12, for example in the case of the embodiment illustrated in FIG. 1 extending to the left and right of the anode 14 and in the direction of the longitudinal extension 10, in which case the other electrodes 45, 46 are respectively supplied with electrical energy in pairs from the power source 40.

Another option is to design the two other electrodes 45, 46 with a cylindrical casing shape so that these two other electrodes 45, 46 are disposed at least partially surrounding the at least one anode 14 and the at least one cathode 15, for example.

In principle, though not preferred, another option is to provide only one other electrode 45 or 46, in which case the opposite electrode in this instance is formed by the at least one anode 14 or the at least one cathode 15 which, unlike the situation where a respective electrode pair is provided, can be connected via a regulating and/or control device. Accordingly, the following explanations should also be read with this in mind.

In particular, it is possible for these three, i.e. anode 14, cathode 15 and other electrode 45 or 46, to be disposed concentrically with one another and at least partially inside one another (the latter having different diameters).

Yet another possibility is for the at least one cathode 15 or the at least one anode 14 to have at least two electrically non-conductive regions connected to one another, namely a region for setting up the electrode pairing of anode 14-cathode 15, and a region for setting up the electrode pairing with the other electrode 45 or 46.

The other electrodes 45, 46 may be made from the same material or different material from one another. In any case, the two other electrodes 45, 46 are made from a metal or a metal alloy. Possible metals which might be used are, for example, Pd, Pt, Ti, Rh, Au, Ag, Ni, Cu, Ir, Fe, V, Nb, Ta and their alloys. During tests run on the device 1, however, it was found to be of advantage to use a silver alloy with a total of up to 25% by weight Ni and/or Nb and/or Ta, in particular a total of up to 15% by weight Ni and/or Nb and/or Ta, or a platinum alloy with a total of up to 20% by weight, in particular a total of 12% by weight, rhodium and/or Ni and/or Ir, to improve the degree of efficiency of the device 1 i.e. achieve better heating power of the device 1, as will be explained in more detail below. In this respect, it is also possible for at least one of the electrodes 45, 46 to have a substrate core comprising a metal substrate for the metals and alloys listed above, in which case it will be made from a less expensive metal or less expensive metal alloy, for example steel, and the metals or alloys listed above are then deposited on this substrate core, in particular galvanically, using a method known from the prior art.

As illustrated in FIG. 1, at least one of the two other electrodes 45, 46 is preferably disposed in the region of the anode 14. If the relative position of the anode 14 with respect to the cathode 15 is reversed so that the cathode 15 is disposed outside of the anode 14 in the reaction chamber 12, it is possible to provide at least one of the two other electrodes 45, 46 in the region of the cathode 15.

Although this is the preferred embodiment of the invention, it would naturally also be possible to dispose these at least two other electrodes 45, 46 in a different region of the reaction chamber 12, for example these other electrodes 45, 46 could be disposed underneath the anode 14 in FIG. 1, in the region formed between the anode 14 and the housing base 4. In any event, the disposition should be such that a free run exists between the two electrodes 45, 46 for the flow of fluid 9 and an arrangement of the two electrodes 45, 46 with the shoulder 21 lying in between is not desirable within the context of the invention.

A distance 48 between these two electrodes 45, 46 is preferably at most 10%, in particular at least 25%, of the length of the reaction chamber 12, i.e. of the longitudinal extension of the reaction chamber 12 in the direction of the longitudinal mid-axis 10 between the housing base 4 and the housing cover 5. The reaction chamber 12 is therefore formed by the region in which the at least one anode 14 and the at least one cathode 15 are disposed. The distance 48 is the shortest distance between these two electrodes 45, 46. In the embodiment illustrated in FIG. 1, this distance 48 is the distance between the two end regions of the two other electrodes 45, 46.

If the two other electrodes 45, 46 are disposed adjacent to one another in the device 1, i.e. in the reaction chamber 12, in order words parallel with one another, this distance 48 is the distance formed between the two surfaces of the electrodes 45, 46 pointing towards one another.

As illustrated in FIG. 1, these two other electrodes 45, 46 are preferably of a bar-shaped design. A diameter 49 of the bar-shaped electrodes 45, 46 has a dimension of at most 30% of the smallest dimension of the at least one cathode 15. In the context of the invention, however, and for the reasons outlined above, it is preferable if this diameter 49 has a maximum value of 20% of the smallest dimension of the at least one cathode 15.

Although, within the scope of the invention, there are more different possibilities as to how the at least two other electrodes 45, 46 are disposed in the reaction chamber 12, it is preferable if these two other electrodes 45, 46 are disposed in the direction of the longitudinal extension 10 of the housing and coaxially with one another in the housing 2, as illustrated in FIG. 1.

Furthermore, the electrodes 45, 46 need not necessarily be in an upright position as illustrated in FIG. 1 and they could also be placed in the reaction chamber 12 in a lying position, i.e. with their biggest longitudinal extension oriented at least approximately perpendicular to the longitudinal mid-axis 10 of the device 1.

The power source 47 for the at least two other electrodes 45, 46 is preferably a constant voltage source of the type known from the prior art. If an alternating voltage is used as the primary power source, this power source 47 preferably has a rectifier.

In one particularly preferred embodiment of the invention, the electrodes 45, 46 are surfaceactivated before they are built into the reaction chamber 12 of the device. To this end, voltage pulses with an amplitude selected from a range of from 5 V to 50 V are applied to the two electrodes 45, 46 in an electrolyte bath. The pulse duration of the voltage pulses is selected from a range with a lower limit of 1 μs and an upper limit of 10 μs. The current intensity is selected from a range with a lower limit of 2000 A and an upper limit of 8000 A. The electrolyte bath in which this activation takes place preferably contain water glass (Na₂SiO₃), at least one lye, in particular KOH, distilled or de-ionized water, and optionally Na₂SO₃ and/or K₂SO₄, The proportion of water glass may be selected from a range of from 0.05% by weight to 10% by weight, in particular 0.1% by weight to 1% by weight. The proportion of lye may be selected from a range of from 0.05% by weight to 5% by weight, in particular 0.1% by weight to 5% by weight. The rest making up 100% by weight is water, provided the electrolyte bath contains no other additives, for example those mentioned above, in which case their proportion is limited to 10% by weight.

As a result of this activation, the surface of the electrodes 45, 46 is changed.

In one embodiment, it is possible to deposit the metals or alloy on the substrate core mentioned above at the same time as the activation takes place.

In the case of another embodiment of the device proposed by the invention, an electrolyte is added to the fluid 9, in particular the water. The electrolyte used may be a conductive salt that is soluble in water or in the fluid, in a manner known from the prior art. In addition to water, however, the electrolyte preferably contains KOH in a proportion of at most 5% by weight.

As already explained above, if water is used as the fluid 9, it may be preferable to add a lye or base or at least one electrolyte to it. This increases the conductivity of the water due to the presence of ions, and the ions also originate from the two other electrodes 45, 46. In this case, it has proved to be of advantage if at least one laser 50, i.e. the light-emitting part of a laser 50, is disposed in the smoothing section 38, as schematically illustrated in FIG. 1. In particular, this light-emitting part of the laser 50 is in turn disposed in the housing shell 3 or alternatively this light-emitting part of the laser 50 may be shifted farther in the direction towards the longitudinal mid-axis 10 of the reaction chamber 12, i.e. the smoothing section 38, for which purpose appropriate devices may be provided in the housing shell 3, for example plug-in sleeves, etc. Alternatively, it would also be possible to make the housing shell 3 from a trans-parent material and beam the laser light into the smoothing section 38 or into the reaction chamber 12 from outside.

The laser 50 is preferably a red light laser and the laser 50 preferably emits light at a frequency selected from a range with a lower limit of 300 THz and an upper limit of 550 THz. Based on one embodiment, the laser 50 may emit intermittent light, in which case the laser 50 has an appropriate device for generating this intermittent light or is connected to one. A pulse duration of the laser light pulse may be selected from a range with a lower limit of 20 μs, in particular 33 μs, and an upper limit of 100 μs, in particular 50 μs.

FIG. 3 illustrates how the material chosen for the two electrodes 45, 46 affects the degree of efficiency of the device 1.

By degree of efficiency in the context of the invention is meant that the ratio of energy picked up to the energy emitted is regarded as heating power.

FIG. 3 shows a bar denoted by 51 using PtNi5 as electrode material, a bar 52 using Pt as electrode material, a bar 53 using an alloy based on the composition AgNi5 as electrode material, a bar 54 using Ni as electrode material and a bar 55 using steel as electrode material.

As may be seen from FIG. 3, the alloy AgNi5 used by preference as electrode material has a significantly higher degree of efficiency than electrodes made from the other materials listed. In this respect, the difference in the degree of efficiency between PtNi5 and AgNi5 as electrode material (bar 51) is apparently only slight but this difference still results in an increase in the degree of efficiency of the device 1 representing 3% to 5% simply by using the electrode material AgNi5, which makes the device 1 more economical and in particular offers the advantage of reducing environmental pollution.

FIG. 4 illustrates what effect activating the surface of the two electrodes 45, 46 has on the degree of efficiency of the device 1. One bar 56 represents the use of non-activated AgNi5 and one bar 57 represents the same electrodes but with an activated surface. As illustrated, activating the surface in the manner described above results in a significant increase in the degree of efficiency compared with electrodes made from the same composition but with non-activated surfaces.

As known from the prior art, the heating system 31 may be operated at a pressure of between 2 bar and 4 bar in the primary circuit, for example. However, it would also be possible for the heating system 31 to be operated without pressure in the primary circuit with a temperature of the fluid 9 close to the boiling point of the fluid 9.

Although it has been mentioned at several points that the heating system 31 or device 1 is used to heat houses, this generally applies to the generation of heat irrespective of the purpose for which this heat will ultimately be used. In order to increase the heating power if necessary, it would be possible to connect several devices 1 one after the other, i.e. in series, in the heating system 31.

### LIST OF REFERENCE NUMBERS

1 Device
2 Housing
3 Housing shell
4 Housing base
5 Housing cover
6 Thread
7 End region
8 End region
9 Fluid
10 Longitudinal mid-axis
11 Inlet opening
12 Reaction chamber
13 Outlet opening
14 Anode
15 Cathode
16 End region
17 Orifice
18 Positive pole
19 Negative pole
20 Pulse generator
21 Shoulder
22 Bore
23 External thread
24 Internal thread
25 Distance
26 Opening
27 Arrow
28 Radial bore
29 Axial bore
30 Bore
31 Heating system
32 Radiator
33 Pump
34 Expansion tank
35 Gas absorber
36 Measuring device
37 Control unit
38 Smoothing section
39 Length
40 Longitudinal extension
41 Width
42 Deflector plate
43 Light-emitting diode
44 Device
45 Electrode
47 Power source
48 Distance
50 Laser
51 Bar
52 Bar
53 Bar
54 Bar
55 Bar
56 Bar
57 Bar

1. Device (1) for heating a fluid (9), with a housing (2) comprising a housing shell (3), a housing base (4) and a housing cover (5), with at least one inlet opening (11) and at least one outlet opening (13) for the fluid (9), and at least two electrodes, in particular at least one anode (14) and at least one cathode (15), are disposed in the housing (2) at a distance (25) apart from one another, which are each electrically conductively connected to a pole of at least one pulse generator (20), wherein at least one other electrode (45 or 46), preferably at least two other electrodes (45, 46), are provided in the reaction chamber (12), which is/are electrically conductively connected to a power source (47).

2. Device (1) according to claim 1, wherein the other electrode (45 or 46) or the at least two other electrodes (45, 46) is/are made from a material selected from a group comprising Pd, Pt, Ti, Rh, Au, Ag, Ni, Cu, Ir, Fe, V, Nb, Ta and their alloys.

3. Device (1) according to claim 1, wherein the other electrode (45 or 46) or at least one of the two other electrodes (45, 46) is/are disposed in the region of one of the at least two electrodes, in particular the anode (14) or the cathode (15).

4. Device (1) according to claim 1, wherein a distance (48) between the at least two other electrodes (45, 46) is at least 10% of the length of a reaction chamber (12) defined by the housing (2).

5. Device (1) according to claim 1, wherein the other electrode (45 or 46) or the at least two other electrodes (45, 46) are of a bar-shaped design with a diameter (49) of at most 30% of the smallest dimension of at least one of the at least two electrodes, in particular the at least one cathode.

6. Device (1) according to claim 1, wherein the power source (47) for the other electrode (45 or 46) or the at least two other electrodes (45, 46) is a constant voltage source.

7. Device (1) according to claim 1, wherein the other electrode (45 or 46) or the at least two other electrodes (45, 46) are activated in an electrolyte bath with voltage pulses with an amplitude selected from a range of from 5 V to 50 V (direct current) and a pulse duration selected from a range of 1 μs to 10 μs at a current intensity selected from a range with a lower limit of 2000 A and an upper limit of 8000 A.

8. Device (1) according to claim 1, wherein the housing (2) contains water with an electrolyte.

9. Device (1) according to claim 8, wherein the electrolyte contains water glass (Na₂SiO₃), at least one lye, in particular KOH, distilled or de-ionized water, and optionally Na₂SO₃ and/or K₂SO₄.

10. Device (1) according to claim 1, wherein the at least two other electrodes (45, 46) are disposed in the direction of a longitudinal extension (10) of the housing (2) and coaxially with one another in the housing (2).

11. Device (1) according to claim 1, wherein a smoothing section (38) for the fluid (9) is disposed after the at least two electrodes, in particular the at least one cathode (15) or the at least one anode (14), in the flow direction—arrow (27)—of the fluid (9).

12. Device (1) according to claim 11, wherein the smoothing section (38) is disposed in the housing (2).

13. Device (1) according to claim 11, wherein the smoothing section (38) has a length (39) which is 100% to 500% bigger than a longitudinal extension (40) of at least one of the at least two electrodes, in particular the anode (14) or the cathode (15), in the flow direction of the fluid (9).

14. Device (1) according to claim 11, wherein the housing (2) has an at least partially bigger clearance width (41) in the region of the smoothing section (38) than in the region in which the at least two electrodes, in particular the cathode (15) and the anode (14), are disposed.

15. Device (1) according to claim 11, wherein at least one deflector plate (42) is disposed in the smoothing section (38).

16. Device (1) according to claim 11, wherein at least one light-emitting diode (43) is disposed in the smoothing section (38).

17. Device (1) according to claim 16, wherein the at least one light-emitting diode (43) emits white light.

18. Device (1) according to claim 16, wherein several light-emitting diodes (43) are disposed in the smoothing section (38), which emit light in a different wavelength spectrum.

19. Device (1) according to claim 16, wherein the light-emitting diode(s) (43) are disposed in a peripheral region of the housing shell (3).

20. Device (1) according to claim 16, wherein the light-emitting diodes (43) are electrically conductively connected to a device (44) for generating an intermittent light.

21. Device (1) according to claim 1, wherein at least one of the least two electrodes, in particular the anode (14), is of a basket-shaped design.

22. Device (1) according to claim 21, wherein at least one of the least two electrodes is disposed at least partially inside the basket-shaped electrode, in particular the at least one cathode (15) is disposed at least partially inside the basket-shaped anode (14).

23. Device (1) according to claim 1, wherein the distance (25) between the at least two electrodes, in particular between the cathode (15) and the anode (14), is at least 5 mm.

24. Device (1) according to claim 1, wherein the housing shell (3) is cylindrical in shape.

25. Device (1) according to claim 1, wherein at least one of the least two electrodes is or are disposed in the housing (2) so as to be relatively displaceable towards the other electrode, in particular the anode (14) is displaceable relative to the cathode (15) and/or the cathode (15) is displaceable relative to the anode (14).

26. Device (1) according to claim 1, wherein at least one laser (50) is disposed in the smoothing section (38).

27. Device (1) according to claim 26, wherein the laser (50) emits light at a frequency selected from a range with a lower limit of 300 THz and an upper limit of 550 THz.

28. Device (1) according to claim 26, wherein the laser (50) is connected to a device for generating an intermittently occurring light.

29. Device (1) according to claim 28, wherein the laser (50) emits light pulses and a pulse duration is selected from a range with a lower limit of 20 μs and an upper limit of 100 μs.

30. Heating system (31) comprising at least one device for conveying a first fluid (9), at least one device (1) for heating of the fluid (9), at least one heat exchanger in which the heat generated by the fluid (9) is transmitted to another fluid, wherein the at least one device (1) for heating a fluid (9) is as defined according to claim 1.

31. Heating system (31) according to claim 30, wherein the heat exchanger is provided in the form of a radiator (32).

32. Use of the device (1) for heating a fluid (9) according to claim 1 to heat a building.
